(19) United States
(12) Patent Application Publication
(10) Pub. No.: US 2025/0148362 A1
(43) Pub. Date: May 8, 2025

(54) APPARATUS AND METHOD FOR MANAGING GIANT MODEL

(71) Applicant: ELECTRONICS AND TELECOMMUNICATIONS RESEARCH INSTITUTE, Daejeon (KR)

(72) Inventors: Myung-Hoon CHA, Daejeon (KR); Ki-Dong KANG, Daejeon (KR); Hong-Yeon KIM, Daejeon (KR); Baik-Song AN, Seoul (KR)

(73) Assignee: ELECTRONICS AND TELECOMMUNICATIONS RESEARCH INSTITUTE, Daejeon (KR)

(21) Appl. No.: 18/678,634

(22) Filed: May 30, 2024

(30) Foreign Application Priority Data
Nov. 7, 2023 (KR) 10-2023-0152641

(51) Int. Cl. G06N 20/00

(52) U.S. Cl. CPC G06N 20/00

(57) ABSTRACT

Disclosed herein is an apparatus and method for managing a giant model. The apparatus includes memory in which at least one program is recorded and a processor for executing the program. The program may perform lightweighting a first model into a second model in consideration of hardware resources, generating partitioning information of the first model based on a result of analysis of the second model, and performing training or inference for the first model based on the generated partitioning information.

### CROSS REFERENCE TO RELATED APPLICATION

This application claims the benefit of Korean Patent Application No. 10-2023-0152641, filed Nov. 7, 2023, which is hereby incorporated by reference in its entirety into this application.

### BACKGROUND OF THE INVENTION

### 1. Technical Field

The disclosed embodiment relates generally to training or inference of an Artificial Intelligence (AI) model, and more particularly to technology for managing a model that is too large to be loaded into memory, thereby enabling training or inference.

### 2. Description of the Related Art

Because a giant model cannot be loaded on a single GPU, it must be partitioned and distributed across multiple GPUs in a cluster of servers connected over a network or in a cloud in order to perform training and inference of the giant model.

In order to perform training/inference by partitioning a model, it is first necessary to analyze how the model should be partitioned. In model training/inference platforms, such as PyTorch and the like, a model definition is instantiated and the instance is analyzed, whereby partitioning information may be extracted. However, because an instance of a giant model cannot even be loaded into CPU memory, an analysis attempt to extract partitioning information fails from the start.

Also, even though a model partitioning method is determined, when the memory resources of individual GPUs/servers where training/inference of the partitioned model pieces is to be actually performed are inefficiently managed, data calculated during the training process is accumulated in GPU and CPU memory over time, and the partitioned model pieces may not be run on the corresponding GPUs/servers due to memory shortages.

Also, when model training/inference is continuously performed in a cluster/cloud, factors degrading the performance of training/inference, i.e., GPU/server failures, may occur, and in this case, it is necessary to newly partition the model and redeploy the same by taking into account the remaining resources. Therefore, if the initially determined model partitioning cannot be changed, it may result in a problem in which it is impossible to maintain long-term training in the cluster/cloud.

The patent WO2022048557, invented by Huawei Cloud Computing Technologies Co., Ltd. and published on Mar. 10, 2022, proposes a method capable of flexibly performing distributed learning using multiple learning modes and container-based learning. However, it does not provide a means for dynamically managing a giant model in consideration of available resources varying during training while enabling analysis of the giant model of which the instance cannot be loaded.

The Korean Patent Application Publication No. 10-2022-0006360, invented by Ulsan National Institute of Science and Technology and published on Jan. 17, 2022, proposes a method based on resource allocation and parameter synchronization in order to train a neural network model in a distributed environment. However, it does not deal with a specific means for enabling a decision on partitioning of a very large model and a dynamic management method according to a change in resources.

### SUMMARY OF THE INVENTION

An object of the disclosed embodiment is to effectively manage a giant model in an environment in which the giant model is partitioned and training/inference is performed in a cluster/cloud configured with multiple GPU servers.

Another object of the disclosed embodiment is to enable analysis for partitioning a giant model.

A further object of the disclosed embodiment is to solve a memory shortage problem such that partitioned model pieces can be continuously executed in corresponding GPUs/servers.

Yet another object of the disclosed embodiment is to efficiently support dynamic management such that initially determined model partitioning can be changed.

An apparatus for managing a giant model according to an embodiment includes memory in which at least one program is recorded and a processor for executing the program, and the program may perform lightweighting a first model into a second model in consideration of hardware resources, generating partitioning information of the first model based on a result of analysis of the second model, and performing training or inference for the first model based on the generated partitioning information.

Here, when lightweighting the first model, the program may perform generating the second model by respectively lightweighting multiple modules constituting the first model and generating a model component map in which the location of each of the multiple modules constituting the first model is mapped to the location of each of the lightweighted multiple modules constituting the second model.

Here, the lightweighted multiple modules constituting the second model may be substitutes for the multiple modules constituting the first model at a model definition file level.

Here, when generating the partitioning information, the program may perform analyzing an instance of the second model by loading the same into memory and splitting the first model into multiple partitions in consideration of hardware resources to be occupied by the multiple modules constituting the first model mapped to the loaded second model with reference to the model component map.

Here, when performing the training or the inference, the program may perform respectively allocating the multiple partitions split from the first model to multiple servers to perform the training or the inference.

Here, when performing the training or the inference, the program may further perform changing the model component map to correspond to each of the multiple partitions split from the first model, and the multiple servers may perform the training or the inference based on the changed model component map.

Here, in the model component map, the location of a module of the second model may be changed to the location of a module of the first model corresponding thereto when the module of the second model is included in the partition, and the locations of the remaining modules of the second model may be removed.

Here, the program may further perform monitoring the hardware resources when the training or the inference is performed; and determining whether to again perform model splitting based on a monitoring result.

Here, when it is determined to again perform model splitting, the program may perform restoring the changed model component map to the original model component map and may again perform operations from splitting the first model.

A method for managing a giant model according to an embodiment may include lightweighting a first model into a second model in consideration of hardware resources, generating partitioning information of the first model based on a result of analysis of the second model, and performing training or inference for the first model based on the generated partitioning information.

Here, lightweighting the first model may include generating the second model by respectively lightweighting multiple modules constituting the first model and generating a model component map in which the location of each of the multiple modules constituting the first model is mapped to the location of each of the lightweighted multiple modules constituting the second model.

Here, the lightweighted multiple modules constituting the second model may be substitutes for the multiple modules constituting the first model at a model definition file level.

Here, generating the partitioning information may include analyzing an instance of the second model by loading the same into memory and splitting the first model into multiple partitions in consideration of hardware resources to be occupied by the multiple modules constituting the first model mapped to the loaded second model with reference to the model component map.

Here, performing the training or the inference may include respectively allocating the multiple partitions split from the first model to multiple servers to perform the training or the inference.

Here, performing the training or the inference may further include changing the model component map to correspond to each of the multiple partitions split from the first model, and the multiple servers may perform the training or the inference based on the changed model component map.

Here, in the model component map, the location of a module of the second model may be changed to the location of a module of the first model corresponding thereto when the module of the second model is included in the partition, and the locations of the remaining modules of the second model may be removed.

Here, the method for managing a giant model according to an embodiment may further include monitoring the hardware resources when the training or the inference is performed; and determining whether to again perform model splitting based on a monitoring result.

Here, when it is determined to again perform model splitting, restoring the changed model component map to the original model component map may be performed, after which the method may be performed again from splitting the first model.

A method for managing a giant model according to an embodiment may include generating a second model by respectively lightweighting multiple modules constituting a first model, generating a model component map in which the location of each of the multiple modules constituting the first model is mapped to the location of each of the lightweighted multiple modules constituting the second model, analyzing an instance of the second model by loading the same into memory, splitting the first model into multiple partitions in consideration of hardware resources to be occupied by the multiple modules constituting the first model mapped to the loaded second model with reference to the model component map, performing training or inference by respectively allocating the multiple partitions split from the first model to multiple servers, monitoring the hardware resources when the training or the inference is performed, and determining whether to again perform model splitting based on a monitoring result.

Here, the method may further include changing the model component map to correspond to each of the multiple partitions split from the first model before performing the training or the inference. In the model component map, the location of a module of the second model may be changed to the location of a module of the first model corresponding thereto when the module of the second model is included in the partition, and the locations of the remaining modules of the second model may be removed. When it is determined to again perform model splitting, restoring the changed model component map to the original model component map may be performed, after which the method may be performed again from splitting the first model.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a schematic block diagram of an apparatus for managing a giant model according to an embodiment;

FIG. 2 is an exemplary view of a model configuration according to an embodiment;

FIG. 3 is an exemplary view for lightweighting a module of a model according to an embodiment;

FIG. 4 is an exemplary view of a model component map according to an embodiment;

FIG. 5 and FIG. 6 are exemplary views of a change in a model component map according to an embodiment;

FIG. 7 is a flowchart for explaining a method for managing a giant model according to an embodiment; and

FIG. 8 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

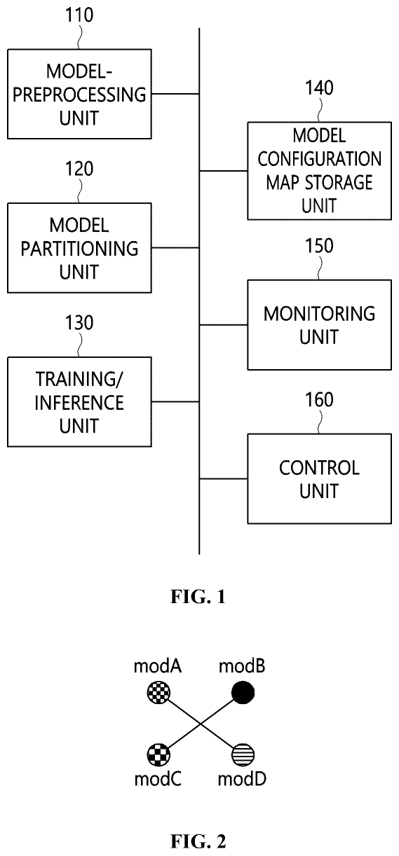

FIG. 1 is a schematic block diagram of an apparatus for managing a giant model according to an embodiment.

Referring to FIG. 1, the apparatus for managing a giant model according to an embodiment may include a model-preprocessing unit 110, a model partitioning unit 120, and a training/inference unit 130.

The apparatus may further include a model configuration map storage unit 140, a monitoring unit 150, and a control unit 160.

The model-preprocessing unit 110 may lightweight a first model into a second model in consideration of hardware resources.

That is, in order to determine partitioning of a giant model in a cluster or cloud configured with GPU servers for training/inference of the first model, the model shape may be preprocessed to be accommodated in a hardware resource range.

The detailed operation of the model-preprocessing unit 110 will be described with reference to FIGS. 2 to 4.

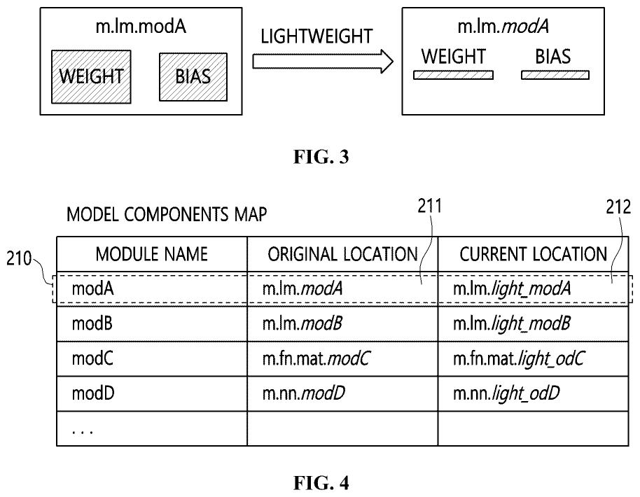

FIG. 2 is an exemplary view of a model configuration according to an embodiment, FIG. 3 is an exemplary view of lightweighting the modules constituting a model according to an embodiment, and FIG. 4 is an exemplary view of a model component map according to an embodiment.

Referring to FIG. 2, a first model may be configured with multiple modules, e.g., modA, modB, modC, and modD.

That is, in the recently widely used training/inference platforms, such as PyTorch and the like, a model is generated by combining model components called ‘modules’ that include weight and bias information of the model, and a giant model may be configured with a large number of modules. Meanwhile, because training/inference platforms that do not use the term ‘module’ also include model components including weights and biases, these model components are referred to in common as ‘modules’.

Here, the model-preprocessing unit 110 may generate a second model by respectively lightweighting the multiple modules of the first model.

Here, the lightweighted multiple modules constituting the second model may be substitutes for the respective multiple modules constituting the first model at a model definition file level. That is, when a model is a giant model of which the instance cannot be loaded, the model is not instantiated, but the components thereof are converted into lightweight components at a model definition file level, whereby the instance can be loaded into memory.

For example, referring to FIG. 3, the weight and bias of the module modA may be lightweighted.

That is, the lightweighted module is a substitute generated by reducing the weight and bias of the original module or a substitute having only a trace of shape information, and may be a component that reduces the size of memory occupied thereby so as to enable instance loading in order to solve a problem in which the instance of a giant model is not even loaded into memory when it is attempted to load the instance of the giant model into memory for analysis thereof.

Also, the model-preprocessing unit 110 may generate a model component map in which the location of each of the multiple modules constituting the first model is mapped to the location of each of the lightweighted multiple modules constituting the second model.

That is, the model component map represents the original components of the model and the components currently used to substitute the original components. The model component map, through which the original component corresponding to the component of the second model can be retrieved, may be stored in the model configuration map storage unit 140.

Referring to FIG. 4, the model component map may include the names of modules of a model (module name), the locations of the modules of the first model (original location), and the locations of the modules of the second model (current location).

For example, the location of module A (modA) before being lightweighted may be mapped to the location thereof after being lightweighted.

Also, the model component map illustrated in FIG. 4 may be a model component map that is used when a model instance is first loaded in the analysis preparation process for partitioning a giant model. The model component map may be changed later in an inference or training process.

Again referring to FIG. 1, the model partitioning unit 120 may generate partitioning information of the first model based on a result of analysis of the second model.

That is, in order to partition a giant model, the recently widely used training/inference platforms, such as PyTorch and the like, generate an instance on memory based on the definition of the model and analyze the instance, thereby determining the point at which the model is to be partitioned.

Here, the model partitioning unit 120 loads the instance of the second model into CPU memory and analyzes the same. That is, because a model instance requiring a smaller amount of memory is loaded into the CPU memory of a single server according to an embodiment, analysis on how to partition the model may be performed.

Here, the model partitioning unit 120 may split the first model into multiple partitions in consideration of the hardware resources to be occupied by the multiple modules of the first model mapped to the loaded second model with reference to the model component map.

The training/inference unit 130 may perform training or inference for the first model based on the generated partitioning information.

Here, the training/inference unit 130 may respectively allocate the multiple partitions split from the first model to multiple servers to perform training or inference.

Meanwhile, because the module lightweighted as shown in FIG. 3 cannot be used in the training/inference process, it needs to be replaced with the original module before a training or inference operation is performed.

Accordingly, the training/inference unit 130 may change the model component map so as to correspond to each of the multiple partitions of the first model.

Here, in the model component map, the location of the module of the second model is changed to the location of the first model corresponding thereto when the module of the second model is included in the partition, and the locations of the remaining modules of the second model may be removed. That is, the module that is not to be used is removed, and the module to be used is updated to the module to be actually loaded into the memory, rather than the lightweighted component.

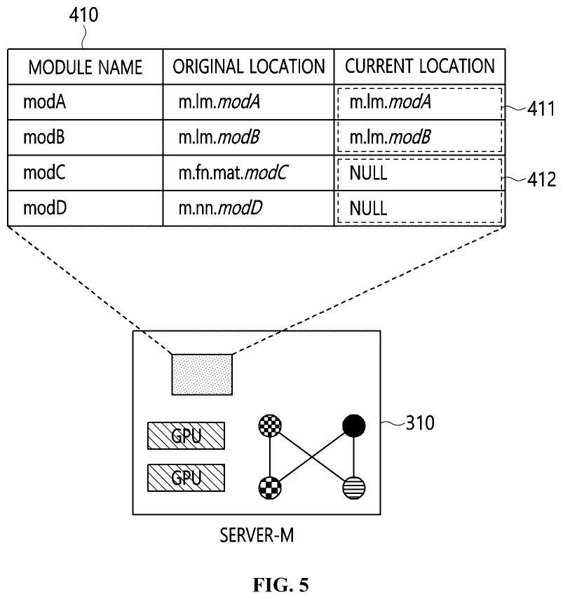

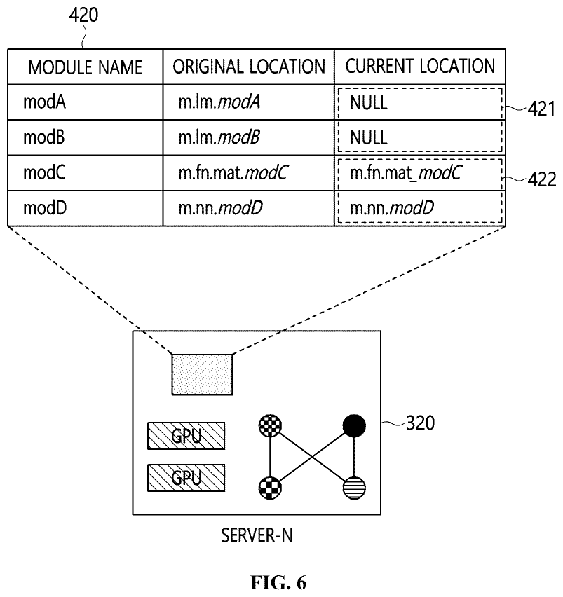

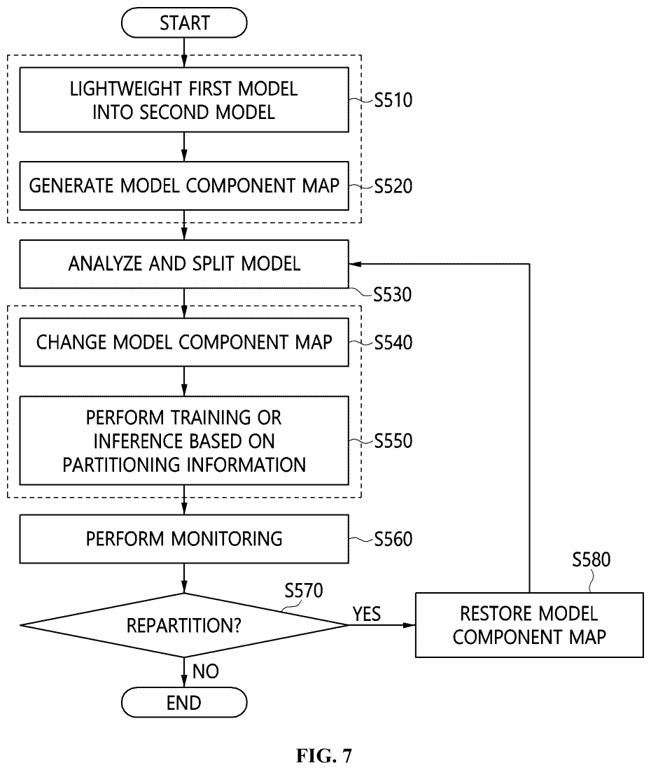

FIG. 5 and FIG. 6 are exemplary views of a change in a model component map according to an embodiment.

Referring to FIG. 5, the modules modA and modB included in one of the partitions split from the first model may be allocated to server-m 310. Also, referring to FIG. 6, the modules modC and modD included in another partition may be allocated to server-n 320.

In the training step, not the lightweighted module used in the preprocessing and analysis step but the actual module has to be loaded onto a GPU. Referring to FIG. 5, it can be seen that the current paths of the modules modA and modB allocated to server-m 310 are updated to the paths 411 of the original modules, rather than the paths of the lightweight modules, in the model component map 410 of server-m 310. Meanwhile, the current paths of the modules modC and modD that are not taken care of by server-m 310 are set to NULL 412, whereby the modules are prevented from being enabled and from unnecessarily occupying memory.

Similarly, referring to FIG. 6, the current paths of the modules modC and modD allocated to server-n 320 are updated to the paths 422 of the original modules, rather than the lightweight modules, in the model component map 420 of server-n 320. Meanwhile, the current paths of the modules modA and modB that are not taken care of by server-n 320 are set to NULL 421, whereby the memory of server-n 320 is prevented from being unnecessarily wasted and the effective modules to be trained are prepared.

Accordingly, each of the multiple servers may perform training or inference by loading the partition based on the model component map changed as described above.

As described above, because only the model components to be actually taken care of by the server are loaded into the CPU memory of the server according to an embodiment, memory space may be efficiently used, and the loaded model components are selectively loaded onto GPUs within the server, whereby training/inference is performed.

Additionally, the monitoring unit 150 may monitor hardware resources when training or inference is performed.

The control unit 160 may further perform determining whether to again partition the model based on the monitoring result. That is, the control unit 160 may determine failures in resources, resource expansion, and the like based on the resource conditions collected by the monitoring unit 150 and restart a model partitioning task.

Here, when it is determined to again perform model partitioning, the control unit 160 may perform control such that the model component map changed by the model-preprocessing unit 110 is restored to the original model component map, and may then sequentially operate the model partitioning unit 120 and the training/inference unit 130.

Here, the reason why the model component map should be restored is that the model component map maintained in each server was changed in the training/inference process, as described above.

As described above, even though it is determined to newly partition the model because the initially determined model partitioning is changed, dynamic management becomes possible using the model component map according to an embodiment. For example, when a GPU server fails during training/inference, model partitioning has to be performed again depending on the remaining available resources, and the model component map is restored such that the original modules are replaced with the lightweight modules, as shown in FIG. 2. Then, the analysis process is restarted by loading the reduced model instance into the CPU memory, how to partition the model is newly determined depending on the remaining resources, and the training/inference process is again performed.

FIG. 7 is a flowchart for explaining a method for managing a giant model according to an embodiment.

Referring to FIG. 7, the method for managing a giant model according to an embodiment may include lightweighting a first model into a second model in consideration of hardware resources at steps S510 to S520, generating partitioning information of the first model based on a result of analysis of the second model at step S530, and performing training or inference for the first model based on the generated partitioning information at steps S540 to S550.

Here, lightweighting the first model at steps S510 to S520 may include generating a second model by lightweighting each of multiple modules constituting the first model at step S510 and generating a model component map in which the location of each of the multiple modules constituting the first model is mapped to the location of each of the lightweighted multiple modules constituting the second model at step S520.

Here, the lightweighted multiple modules constituting the second model may be substitutes for the respective multiple modules constituting the first model at a model definition file level.

Here, generating the partitioning information at step S530 may include analyzing the instance of the second model by loading the same into memory and splitting the first model into multiple partitions in consideration of the hardware resources to be occupied by the multiple modules constituting the first model mapped to the loaded second model with reference to the model component map.

Here, performing training or inference at steps S540 to S550 may include respectively allocating the multiple partitions split from the first model to the multiple servers to perform training or inference.

Here, performing training or inference may further include changing the model component map so as to correspond to each of the multiple partitions split from the first model at step S540, and the multiple servers may perform training or inference at step S550 based on the changed model component map.

Here, in the model component map, the location of a module of the second model is changed to the location of a module of the first model corresponding thereto when the module of the second model is included in the partition, and the locations of the remaining modules of the second model may be removed.

Here, the method for managing a giant model according to an embodiment may further include monitoring hardware resources at step S560 when training or inference is performed and determining whether to again perform splitting the model based on the monitoring result at step S570.

Here, when it is determined to again perform splitting the model, restoring the changed model component map to the original model component map is performed at step S580, after which the method may be performed again from the step (S530) of splitting the model.

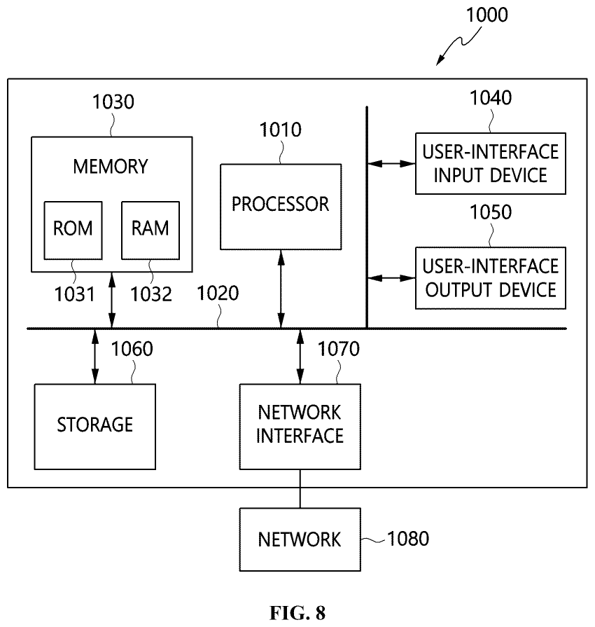

FIG. 8 is a view illustrating a computer system configuration according to an embodiment.

The apparatus for managing a giant model according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, a giant model may be effectively managed in an environment in which the giant model is partitioned and training/inference is performed in a cluster/cloud configured with multiple GPU servers.

According to the disclosed embodiment, analysis for partitioning a giant model is enabled.

According to the disclosed embodiment, a memory shortage problem may be solved such that partitioned model pieces can be continuously executed in corresponding GPUs/servers.

According to the disclosed embodiment, dynamic management may be efficiently performed such that initially determined model partitioning can be changed in consideration of available resource conditions varying during training/inference.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. An apparatus for managing a giant model, comprising:
memory in which at least one program is recorded; and
a processor for executing the program,
wherein the program performs
lightweighting a first model into a second model in consideration of hardware resources,
generating partitioning information of the first model based on a result of analysis of the second model, and
performing training or inference for the first model based on the generated partitioning information.

2. The apparatus of claim 1, wherein, when lightweighting the first model, the program performs
generating the second model by respectively lightweighting multiple modules constituting the first model, and
generating a model component map in which a location of each of the multiple modules constituting the first model is mapped to a location of each of the lightweighted multiple modules constituting the second model.

3. The apparatus of claim 2, wherein the lightweighted multiple modules constituting the second model are substitutes for the multiple modules constituting the first model at a model definition file level.

4. The apparatus of claim 2, wherein, when generating the partitioning information, the program performs
analyzing an instance of the second model by loading the instance into memory, and
splitting the first model into multiple partitions in consideration of hardware resources to be occupied by the multiple modules constituting the first model mapped to the loaded second model with reference to the model component map.

5. The apparatus of claim 4, wherein, when performing the training or the inference, the program performs
respectively allocating the multiple partitions split from the first model to multiple servers to perform the training or the inference.

6. The apparatus of claim 5, wherein
when performing the training or the inference, the program further performs changing the model component map to correspond to each of the multiple partitions split from the first model, and
the multiple servers perform the training or the inference based on the changed model component map.

7. The apparatus of claim 6, wherein, in the model component map,
a location of a module of the second model is changed to a location of a module of the first model corresponding thereto when the module of the second model is included in the partition, and
locations of remaining modules of the second model are removed.

8. The apparatus of claim 6, wherein the program further performs
monitoring the hardware resources when the training or the inference is performed, and
determining whether to again perform model splitting based on a monitoring result.

9. The apparatus of claim 8, wherein, when it is determined to again perform model splitting, the program performs restoring the changed model component map to the original model component map and again performs operations from splitting the first model.

10. A method for managing a giant model, comprising:
lightweighting a first model into a second model in consideration of hardware resources;
generating partitioning information of the first model based on a result of analysis of the second model; and
performing training or inference for the first model based on the generated partitioning information.

11. The method of claim 10, wherein lightweighting the first model includes
generating the second model by respectively lightweighting multiple modules constituting the first model, and
generating a model component map in which a location of each of the multiple modules constituting the first model is mapped to a location of each of the lightweighted multiple modules constituting the second model.

12. The method of claim 11, wherein the lightweighted multiple modules constituting the second model are substitutes for the multiple modules constituting the first model at a model definition file level.

13. The method of claim 11, wherein generating the partitioning information includes
analyzing an instance of the second model by loading the instance into memory, and
splitting the first model into multiple partitions in consideration of hardware resources to be occupied by the multiple modules constituting the first model mapped to the loaded second model with reference to the model component map.

14. The method of claim 13, wherein performing the training or the inference includes
respectively allocating the multiple partitions split from the first model to multiple servers to perform the training or the inference.

15. The method of claim 14, wherein:
performing the training or the inference further includes changing the model component map to correspond to each of the multiple partitions split from the first model, and
the multiple servers perform the training or the inference based on the changed model component map.

16. The method of claim 15, wherein, in the model component map,
a location of a module of the second model is changed to a location of a module of the first model corresponding thereto when the module of the second model is included in the partition, and
locations of remaining modules of the second model are removed.

17. The method of claim 15, further comprising:
monitoring the hardware resources when the training or the inference is performed, and
determining whether to again perform model splitting based on a monitoring result.

18. The method of claim 17, wherein
when it is determined to again perform model splitting, restoring the changed model component map to the original model component map is performed, and the method is performed again from splitting the first model.

19. A method for managing a giant model, comprising:
generating a second model by respectively lightweighting multiple modules constituting a first model;
generating a model component map in which a location of each of the multiple modules constituting the first model is mapped to a location of each of the lightweighted multiple modules constituting the second model;
analyzing an instance of the second model by loading the instance into memory;
splitting the first model into multiple partitions in consideration of hardware resources to be occupied by the multiple modules constituting the first model mapped to the loaded second model with reference to the model component map;
performing training or inference by respectively allocating the multiple partitions split from the first model to multiple servers;
monitoring the hardware resources when the training or the inference is performed; and
determining whether to again perform model splitting based on a monitoring result.

20. The method of claim 19, further comprising;
before performing the training or the inference, changing the model component map to correspond to each of the multiple partitions split from the first model,
wherein
in the model component map, a location of a module of the second model is changed to a location of a module of the first model corresponding thereto when the module of the second model is included in the partition, and locations of remaining modules of the second model are removed, and
when it is determined to again perform model splitting, restoring the changed model component map to the original model component map is performed, and then the method is performed again from splitting the first model.
